(19) United States
(12) Patent Application Publication
(10) Pub. No.: US 2026/0307352 A1
(43) Pub. Date: Oct. 8, 2026

(54) TIRE HEATING PRESS AND METHOD FOR PRODUCING TIRES

(71) Applicant: HARBURG-FREUDENBERGER MASCHINENBAU GMBH, Hamburg (DE)

(72) Inventors: Stefan BAHLKE, Lüneburg (DE); David LACZKOWSKI, Kaltenkirchen (DE)

(21) Appl. No.: 19/482,327

(22) PCT Filed: Mar. 25, 2024
(86) PCT No.: PCT/DE2024/100253

§ 371 Date: Nov. 7, 2025

(30) Foreign Application Priority Data
May 8, 2023 (DE) 10 2023 111 981.8

(51) Int. Cl. B29D 30/06

(52) U.S. Cl. CPC B29D 30/065; B29D 30/0605; B29D 2030/0651

(57) ABSTRACT

A tire heating press and a method for producing tires, wherein the tire heating press is designed as a column press having two cavities arranged next to each other, wherein the tire heating press has a lower part and an upper part, which can be moved vertically relative to the lower part for opening and closing the cavities with the aid of at least one drive unit. All columns are arranged between the lateral ends of the cavities facing away from each other, so that the width of the tire heating press is defined by the adjacent cavities. The method for producing tires allows joint control of the adjacent cavities.

The invention relates to a tire heating press with two cavities arranged next to each other, wherein the tire heating press is designed as a column press with at least two columns.

In addition, the invention relates to a method for producing tires with a tire heating press.

Tire heating presses have at least one cavity in which a supplied green tire is vulcanized using heat and pressure. The cavity is opened for loading and unloading, while it is closed for vulcanizing the tire.

Tire heating presses with two cavities arranged next to each other are already known and, compared to two tire heating presses with only one cavity each, serve to reduce costs and space requirements.

The space required for setting up tire heating presses at the production site is an important feature of a tire heating press. The less space required, the more tire heating presses can be set up in a given area.

It is therefore an object of the invention to provide a tire heating press with two cavities arranged side by side and at least two columns, which requires less space than known designs.

This object is achieved by a tire heating press according to patent claim 1.

A further object of the invention is to provide a method for producing tires in which two cavities of a tire heating press can be operated in a common mode.

This object is achieved by a method for producing tires according to patent claim 12.

The dependent patent claims claim advantageous embodiments of the invention.

The features of a tire heating press and a method for producing tires disclosed below are part of the invention in all practicable combinations.

A tire heating press according to the invention is designed as a column press and has two cavities arranged next to each other and at least two columns.

In embodiments of the invention, the columns are designed as fixed columns. Compared to swiveling or retractable columns, fixed columns allow the tire heating press to take up less space, so that during operation of the tire heating press, no space needs to be reserved in front of or behind the tire heating press for swiveling the upper part of the press to open it, or below the tire heating press for retracting the columns.

In embodiments of the invention, fixed columns are not pivotable and not retractable, but are stationary and immovable in all functional states of the assembled tire heating press.

In embodiments of the invention, the tire heating press has exactly two columns.

The tire heating press is divided into a lower part and an upper part, wherein the upper part can be moved vertically relative to the lower part for opening and closing the cavities.

In embodiments of the invention, the at least two columns are designed to guide the upper part of the press.

The at least two columns are arranged vertically in their longitudinal direction.

In embodiments of the invention, the columns are designed as round guides.

In embodiments of the invention, the columns are fixedly connected to the lower part of the press and the upper part of the press is guided in its movement along the columns. Preferably, the columns in these embodiments of the invention are designed as fixed columns.

In other embodiments of the invention, the columns are firmly connected to the upper part of the press and are guided in the area of the lower part of the press. In such embodiments of the invention, the columns are preferably retractable into a floor on which the tire heating press is installed.

The tire heating press according to the invention has at least one drive unit for moving the upper part of the press relative to the lower part of the press.

In embodiments of the invention, the at least one drive unit can be operated electrically and/or hydraulically.

In embodiments of the invention, at least one drive unit is implemented as a cylinder, in particular as a hydraulic cylinder.

However, embodiments with other drive units are also conceivable. It is important that these are suitable for lifting the weight of the upper part of the press in a vertical direction or lowering it in a controlled manner.

In embodiments of the invention with one drive unit, this is preferably arranged centrally between two of the columns.

In embodiments of the invention, each of the at least two columns is assigned a separate drive unit and arranged in the area of the respective column.

In embodiments of the invention, the assigned drive unit is arranged close to the respective column.

In other embodiments of the invention, a drive unit is integrated into at least one of the columns.

In an advantageous embodiment of the invention with at least one cylinder as a drive unit, this is arranged so that the force is transferred directly into the floor on which the tire heating press is set up.

The parts of the adjacent cavities arranged on the upper part of the press are mechanically connected to each other so that they can be moved together.

The mechanical connection between the cavities enables the two cavities to be moved together in embodiments of the invention. This means that the cavities can be controlled synchronously for the vulcanization process, in particular for opening and closing the cavities.

In embodiments of the invention, hood-like parts of the cavities are arranged on the upper part of the press.

In preferred embodiments of the invention, the adjacent cavities are arranged very close to each other. This enables a particularly narrow width of the tire heating press. Preferably, the adjacent parts of the cavities in the upper part of the press are arranged so close to each other that they just do not touch.

In embodiments of the invention, all columns are arranged between the lateral ends of the cavities facing away from each other, so that the width of the tire heating press is defined by the adjacent cavities.

In embodiments of the invention, the columns are arranged completely within the area defined by the smallest rectangle enclosing the cavities in a top view. This means that the width and depth of the tire heating press are defined by the width and depth of the cavities and are not increased by columns standing outside the cavities.

In preferred embodiments of the invention, at least two columns are arranged in the space between the two cavities. This allows for a particularly narrow width of the tire heating press.

If all columns are arranged in the space between the two cavities, the cavities are freely accessible from the outside without columns blocking the way, for example for loading and/or unloading devices.

In embodiments of the invention, the cavities have a circular or circle-like contour when viewed from above.

In embodiments of the invention, the space between the cavities results from the free space in a top view between the cavities and between the two tangents, which each touch the outer points of the two cavities on one side.

In advantageous embodiments of the invention, at least one column is arranged in the front space between the cavities and at least one column is arranged in the rear space between the cavities.

In embodiments of the invention, the at least two columns are arranged on a straight line that runs through the center of gravity of the upper part of the press.

In embodiments of the invention, column positions are also conceivable which are displaced in the horizontal direction perpendicular to the connecting line of the centers of the cavities outwards from the space between the cavities.

In particularly advantageous embodiments of the invention, the at least one column in the front space is arranged symmetrically to the at least one column in the rear space in a top view, with the connecting line of the centers of the cavities serving as the axis of symmetry.

In particularly preferred embodiments of the invention, the columns are arranged on a horizontal straight line that intersects the connecting line of the centers of the cavities perpendicularly in the middle. In a symmetrical design of the upper part of the press, this corresponds to the straight line passing through the center of mass of the upper part of the press.

Preferably, both the at least two columns and the at least one drive unit are arranged on this straight line. This enables uniform movement of the upper part of the press with respect to both cavities.

In other embodiments of the invention, at least one fixed column is arranged laterally adjacent to the cavities. For example, a fixed column is arranged on the straight line connecting the centers of the cavities, outside adjacent to a cavity.

In other embodiments of the invention, at least one fixed column is arranged laterally adjacent to the cavities and at least one fixed column is arranged in the space between the cavities.

In advantageous embodiments of the invention with at least one cylinder as the drive unit, the upper part of the tire heating press has at least one extension connected to the cavities and protruding upward beyond them, which allows the tire heating press to be set up at ground level while providing the stroke required to open the cavities completely. The point of attachment of the at least one cylinder on the upper part of the press is set so far upward with the aid of the extension that the required stroke can be achieved.

In embodiments of the tire heating press according to the invention, it has at least one loading and/or unloading device.

A method for producing tires according to the invention comprises at least the following steps:
Joint opening of two cavities of a tire heating press arranged next to each other,
loading the cavities with one green tire each using at least one loading device,
jointly closing the two cavities,
Vulcanization of the tires in the two cavities,
Simultaneous opening of the two cavities,
Unloading of the two cavities using at least one unloading device.

In advantageous embodiments of the invention, the cavities are loaded and/or unloaded simultaneously so that the loading and/or unloading process can be carried out more quickly.

According to the invention, in preferred embodiments of the method for producing tires, a tire heating press according to the invention is used.

The figures described below represent an exemplary embodiment of the invention. They show:

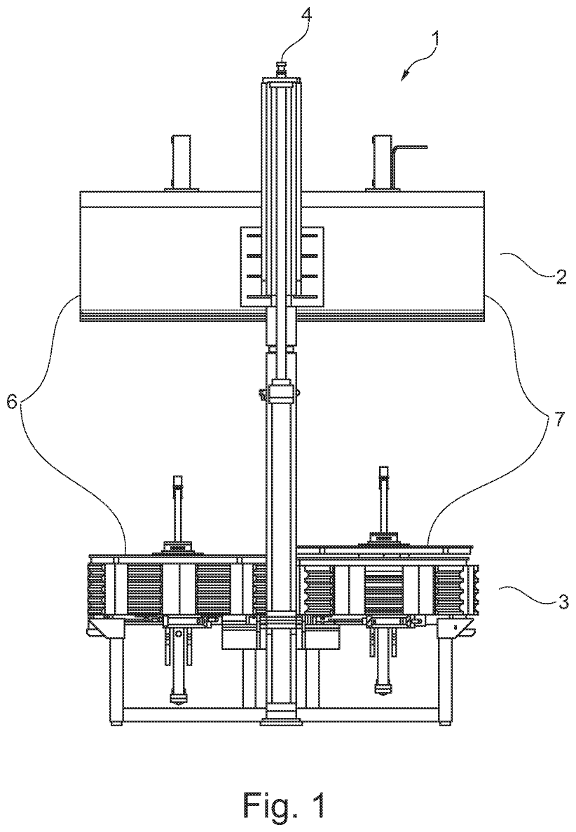

FIG. 1: A side view of a tire heating press according to the invention from the front,

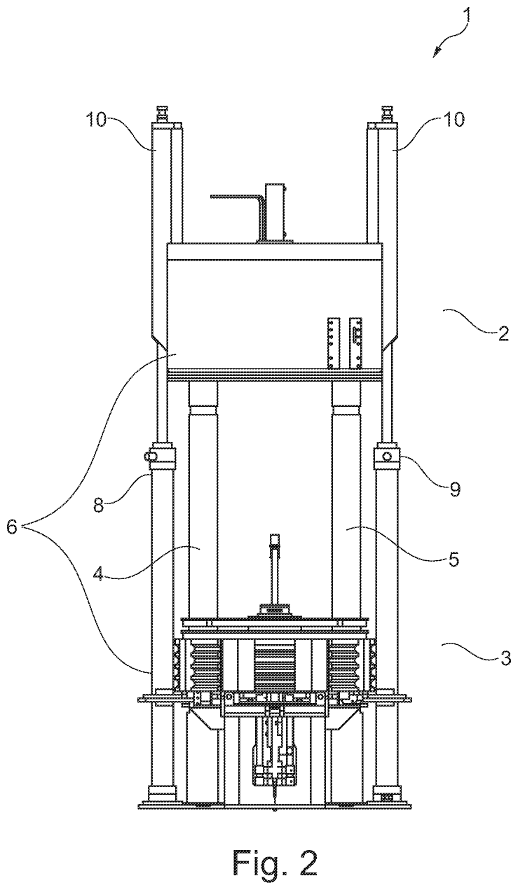

FIG. 2: A side view of a tire heating press according to the invention in a perspective rotated by 90° relative to FIG. 1, and

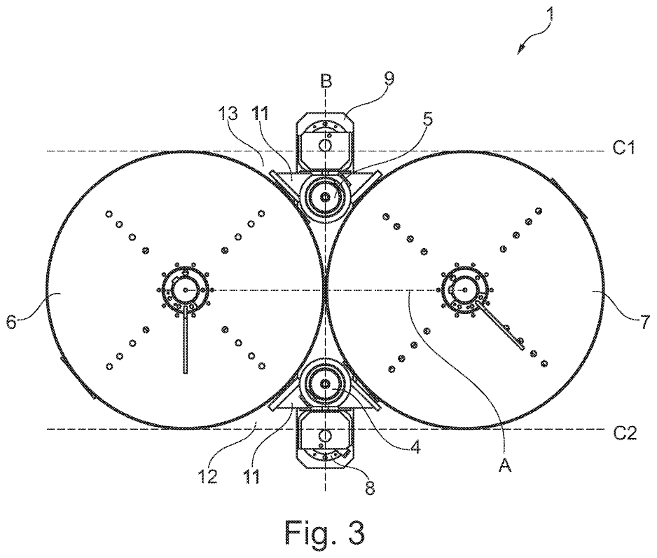

FIG. 3: A top view of a tire heating press according to the invention.

FIG. 1 shows a side view of an embodiment of a tire heating press (1) according to the invention.

The tire heating press (1) has a press upper part (2), a press lower part (3), and at least two columns (4, 5). The upper part (2) can be moved relative to the lower part (3) and is guided along the vertically aligned columns (4, 5). Only the first column (4) is visible in the illustration shown; the second column (5) is concealed by the first column.

The tire heating press (1) has two cavities (6, 7) arranged next to each other, which are shown in an open state.

FIG. 2 shows the embodiment of a tire heating press (1) shown in FIG. 1 in a side view rotated by 90° relative to this.

Next to the first column (4) and the second column (5) is a drive device (8, 9) in the form of a cylinder, which is used to move the upper part (2) of the press relative to the lower part (3) of the press in order to open and close the cavities (6, 7). The columns (4, 5) lie within the width defined by the cavities (6, 7) and are thus arranged in the space between the cavities (6, 7).

In the embodiment shown, the drive devices (8, 9) are each arranged outside next to the columns (4, 5). However, embodiments with at least one drive device (8, 9) arranged between the columns (4, 5) are also conceivable.

The drive devices (8, 9) are each attached to the upper part (2) of the press by means of a fastening element (10).

The drive devices (8, 9), the columns (4, 5), and the lower part of the press (3) are firmly connected to each other via a frame construction.

FIG. 3 shows a top view of an embodiment of a tire heating press (1) according to the invention.

The parts of the cavities (6, 7) arranged on the upper part (2) of the press are mechanically and firmly connected to each other by connecting elements (11). Furthermore, in the embodiment shown, the connecting elements (11) form sleeves running on the columns (4, 5), so that the upper part (2) of the press is guided along the columns (4, 5).

The cavities (6, 7) are arranged directly next to each other.

Drive devices (8, 9) are arranged outside next to the columns (4, 5), each of which is connected to the upper part (2) of the press by a connecting element (11).

The columns (4, 5) are centrally arranged in the space between the cavities (6, 7), with the first column (4) being arranged in the front space (12) and the second column (5) being arranged in the rear space (13).

The intermediate space is bounded in plan view by the adjacent sides of the cavities (6, 7) facing each other and the tangents C1 and C2.

In the advantageous embodiment shown, the columns (4, 5) are spaced apart from each other only to such an extent that the diameter of the sleeve running on the respective column (4, 5) corresponds approximately to the distance between the cavities (6, 7) at the respective points or is slightly smaller. This reduces the depth of the tire heating press (1) compared to designs with columns arranged further apart.

In other embodiments of the invention, the upper part of the press (2) is guided along the columns (4, 5) by means of different elements. For example, pins running in a groove in the column (4, 5) or elements only partially surrounding the column (4, 5) are conceivable.

In the embodiment of the invention shown, the centers of the columns (4, 5) and the drive devices (8, 9) in the cross-section of the top view lie on the straight line (B) perpendicular to the connecting line (A) of the centers of the cavities (6, 7).

1-13. (canceled)

14. A tire heating press configured as a column press having two adjacent cavities arranged next to each other, the tire heating press comprising: at least two columns; a lower part; an upper part movable vertically relative to the lower part for opening and closing the cavities; and at least one drive unit configured to move the upper part, wherein all the columns are arranged between lateral ends of the cavities facing away from each other so that a width of the tire heating press is defined by the adjacent cavities.

15. The tire heating press according to claim 14, wherein the at least two columns are configured to guide the upper part of the press.

16. The tire heating press according to claim 14, wherein the at least one drive unit includes a separate drive unit assigned to each of the at least two columns and arranged in an area of the respective column.

17. The tire heating press according to claim 14, wherein the parts of the adjacent cavities arranged on the upper part of the press are mechanically connected to each other so as to be movable together.

18. The tire heating press according to claim 14, wherein the columns are arranged completely within an area defined by a smallest rectangle enclosing the cavities in a top view.

19. The tire heating press according to claim 14, wherein the at least two columns are arranged in a space between the two cavities.

20. The tire heating press according to claim 19, wherein at least one of the columns is arranged in a front space between the cavities and at least one of the columns is arranged in a rear space between the cavities.

21. The tire heating press according to claim 20, wherein the at least one column in the front space is arranged symmetrically to the at least one column in the rear space in a top view, wherein a connecting line of centers of the cavities serves as an axis of symmetry.

22. The tire heating press according to claim 21, wherein, in a top view, the columns are arranged on a horizontal straight line that intersects the connecting line of the centers of the cavities perpendicularly in the middle.

23. The tire heating press according to claim 20, wherein the at least two columns are arranged on a straight line that runs through a center of mass of the upper part of the press.

24. The tire heating press according to claim 21, wherein the at least one drive unit is arranged on a straight line passing through the positions of the columns.

25. A method for producing tires, comprising the steps of:
a. jointly opening two cavities of a tire heating press arranged next to each other;
b. loading the cavities with one green tire each using at least one loading device;
c. jointly closing the two cavities;
d. vulcanizing the green tires in the two cavities;
e. simultaneously opening the two cavities; and
f. unloading the two cavities using at least one unloading device.

26. The method according to claim 25, including using a tire heating press configured as a column press having two adjacent cavities arranged next to each other, the tire heating press comprising: at least two columns; a lower part; an upper part movable vertically relative to the lower part for opening and closing the cavities; and at least one drive unit configured to move the upper part, wherein all the columns are arranged between lateral ends of the cavities facing away from each other so that a width of the tire heating press is defined by the adjacent cavities.
